(19) United States
(12) Patent Application Publication
(10) Pub. No.: US 2023/0131409 A1
(43) Pub. Date: Apr. 27, 2023

(54) METHOD FOR PRODUCING COATING LAYER WITH SCRATCH RESISTANCE AND FLEX RESISTANCE, LAMINATED STRUCTURE, AND COATING COMPOSITION

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Yi-Chen Chou, TAIPEI (TW)

(21) Appl. No.: 17/870,842

(22) Filed: Jul. 22, 2022

(30) Foreign Application Priority Data
Oct. 25, 2021 (TW) 110139436

(51) Int. Cl. C09D 183/06; C09D 7/20; C09D 7/63; C09D 163/00

(52) U.S. Cl. CPC C09D 183/06; C09D 7/20; C09D 7/63; C09D 163/00

(57) ABSTRACT

A method for producing a coating layer with scratch resistance and flex resistance, a laminated structure, and a coating composition are provided. The method includes coating the coating composition on a plastic substrate and performing a curing operation on the coating composition to form a cured coating layer. The coating composition includes a polyhedral oligomeric silsesquioxane, a multifunctional epoxy resin, a cationic light initiator, and an organic solvent, and the polyhedral oligomeric silsesquioxane has a cage-like structure. The curing operation has a baking temperature that is within a range from 75° C. to 200° C., a baking time that is within a range from 30 s to 120 s, and an UV curing energy that is within a range from 250 mJ/cm² to 1,250 mJ/cm².

### CROSS-REFERENCE TO RELATED PATENT APPLICATION

This application claims the benefit of priority to Taiwan Patent Application No. 110139436, filed on Oct. 25, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for producing a coating layer, and more particularly to a method for producing a coating layer with scratch resistance and flex resistance, a laminated structure, and a coating composition.

### BACKGROUND OF THE DISCLOSURE

In recent development of displays, conventional glass substrates are being gradually replaced with plastic substrates with thin and flexible properties, of which colorless polyimide (CPI) soft materials that are transparent have attracted much market attention.

In order to protect the material surface of the plastic substrates, one solution used by the conventional technology is coating at least one anti-scratch layer on the material surface of the plastic substrates, so that the plastic substrates have scratch resistance and flexibility. However, the above-mentioned solutions of the conventional technology are expensive and can only be applied on high-level products.

In addition, in the related arts, a treatment agent for providing scratch resistance, wear resistance, or anti-glare is coated on the surface of the plastic substrates to form a functional protective film that is used in panel materials or electronic products. However, a pencil hardness of the conventional protective film can generally achieve a grade of 2H or 3H. If the pencil hardness of the surface of the protective film is too great, the flexibility of the plastic substrates may be affected.

### SUMMARY OF THE DISCLOSURE

In response to the above-referenced technical inadequacies, the present disclosure provides a method for producing a coating layer with scratch resistance and flex resistance, a laminated structure, and a coating composition.

In one aspect, the present disclosure provides a method for producing a coating layer with scratch resistance and flex resistance, and the method includes coating a coating composition on a plastic substrate and performing a curing operation on the coating composition to form a cured coating layer. The coating composition contains a polyhedral oligomeric silsesquioxane, a multifunctional epoxy resin, a cationic light initiator, and an organic solvent, and the polyhedral oligomeric silsesquioxane has a cage-like structure. The curing operation has a baking temperature that is within a range from 75° C. to 200° C., a baking time that is within a range from 30 s to 120 s, and an UV curing energy that is within a range from 250 mJ/cm² to 1,250 mJ/cm². The cured coating layer has a pencil hardness that is not less than 4H, a bending radius that is no more than 3 mm, and a visible light transmittance that is not less than 90%.

In certain embodiments, the polyhedral oligomeric silsesquioxane is a modified alicyclic group.

In certain embodiments, the plastic substrate is selected according to following conditions: the plastic substrate being evaluated according to heat resistance, with a baking temperature that is within a range from 150° C. to 250° C., a baking time that is within a range from 2 hours to 4 hours, a longitudinal shrinkage rate of the plastic substrate that is no more than 0.5, a transverse shrinkage rate of the plastic substrate that is no more than 0.3, and a haze difference between the plastic substrate before and after baking that is no more than 20%.

In certain embodiments, the plastic substrate is formed by a resin material, and the resin material is at least one material selected from a group consisting of polyethylene terephthalate, polyvinyl chloride, polycarbonate, polypropylene, and poly(methyl methacrylate).

In certain embodiments, the organic solvent is at least one material selected from a group consisting of methyl ethyl ketone, propylene glycol methyl ether acetate, propylene glycol monomethyl ether, ethyl ethanoate, and methyl isobutyl ketone.

In certain embodiments, based on a total weight of the coating composition being 100 wt %, a content of the polyhedral oligomeric silsesquioxane is within a range from 6 wt % to 40 wt %, a content of the multifunctional epoxy resin is within a range from 3 wt % to 35 wt %, a content of the cationic light initiator is within a range from 1 wt % to 10 wt %, and a content of the organic solvent is within a range from 30 wt % to 70 wt %.

In certain embodiments, the coating composition further contains a processing aid, and a content of the processing aid is within a range from 5 wt % to 30 wt %.

In certain embodiments, before coating the coating composition on the plastic substrate, the method further includes performing a corona treatment and/or coating a surfactant on a coating surface of the plastic substrate.

In certain embodiments, a thickness of the plastic substrate is within a range from 38 μm to 250 μm, and a thickness of the cured coating layer is within a range from 3 μm to 50 μm.

In another aspect, the present disclosure provides a laminated structure, and the laminated structure includes a plastic substrate and a cured coating layer. The cured coating layer is formed on the plastic substrate and contains a polyhedral oligomeric silsesquioxane and a multifunctional epoxy resin, in which the polyhedral oligomeric silsesquioxane has a cage-like structure. The cured coating layer has a pencil hardness that is not less than 4H, a bending radius that is no more than 3 mm, and a visible light transmittance that is not less than 90%.

In certain embodiments, the plastic substrate is selected according to following conditions: the plastic substrate being evaluated according to heat resistance, with a baking temperature that is within a range from 150° C. to 250° C., and a baking time that is within a range from 2 hours to 4 hours, a longitudinal shrinkage rate of the plastic substrate that is no more than 0.5, a transverse shrinkage rate of the plastic substrate that is no more than 0.3, and a haze difference between the plastic substrate before and after baking that is no more than 20%.

In yet another aspect, the present disclosure provides a coating composition, the coating composition contains a polyhedral oligomeric silsesquioxane, a multifunctional epoxy resin, a cationic light initiator, and an organic solvent, and the polyhedral oligomeric silsesquioxane has a cage-like structure. Based on a total weight of the coating composition being 100 wt %, a content of the polyhedral oligomeric silsesquioxane is within a range from 6 wt % to 40 wt %, a content of the multifunctional epoxy resin is within a range from 3 wt % to 35 wt %, a content of the cationic light initiator is within a range from 1 wt % to 10 wt %, and a content of the organic solvent is within a range from 30 wt % to 70 wt %.

Therefore, in the method for producing the coating layer with scratch resistance and flex resistance, the laminated structure, and the coating composition provided by the present disclosure, by virtue of “conditional material selection of the coating composition” and “process conditions for the curing operation,” the cured coating layer has high scratch resistance, flex resistance, and transparency, so that the cured coating layer of the present disclosure has the potential to replace the transparent colorless polyimide films that are used in applications such as cover plates or functional protective films of panel materials or electronic products. Furthermore, compared to the transparent colorless polyimide film, the cost of the cured coating layer of the embodiment of the present disclosure can provide higher market competitiveness.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a coating layer with scratch resistance and flex resistance according to an embodiment of the present disclosure;

FIG. 2 is a schematic view of a step S110 of the method according to the embodiment of the present disclosure; and

FIG. 3 is a schematic view of a step S120 of the method according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Method for Producing Coating Layer

One of the purposes of the present disclosure is to break through the limit to the surface hardness of general plastic materials, keeping the soft and flexible properties of the plastic materials, and having transparency at the same time.

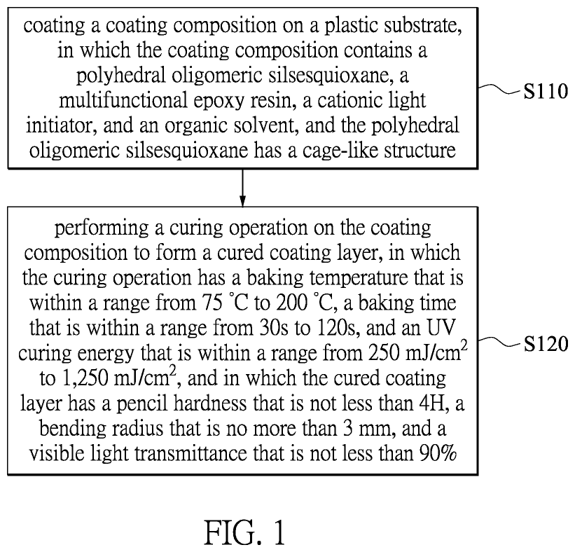

In order to achieve the above-mentioned purpose, as shown in FIG. 1 to FIG. 3, an embodiment of the present disclosure provides a method for producing a coating layer, and more particularly to a method for producing a coating layer with scratch resistance and flex resistance. The method includes a step S110 and a step S120. It should be noted that, the order of each step and the actual operation described in the embodiment can be adjusted according to practical requirements, and are not limited to the present embodiment.

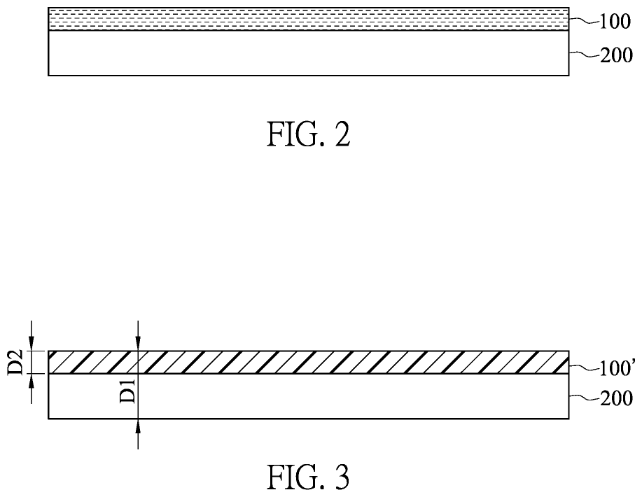

As shown in FIG. 2, the step S110 includes coating a coating composition 100 on a plastic substrate 200.

The coating composition 100 includes a polyhedral oligomeric silsesquioxane (POSS), a multifunctional epoxy resin, a cationic light initiator, an organic solvent, and a processing aid.

In some embodiments of the present disclosure, the polyhedral oligomeric silsesquioxane is a mixture of inorganic and organic materials, and the polyhedral oligomeric silsesquioxane has a cage-like structure so that the polyhedral oligomeric silsesquioxane has flex resistance. In addition, the polyhedral oligomeric silsesquioxane has a compact polymer structure that has a high crosslink density, so that the polyhedral oligomeric silsesquioxane has scratch resistant properties.

The polyhedral oligomeric silsesquioxane has a weight average molecular weight (Mw) that is within a range from 3,000 g/mol to 20,000 g/mol and a glass transition temperature (Tg) that is within a range from −50° C. to 0° C. Furthermore, the polyhedral oligomeric silsesquioxane is preferably a modified polyhedral oligomeric silsesquioxane resin (modified POSS), but the present disclosure is not limited thereto. More specifically, the polyhedral oligomeric silsesquioxane (POSS) is mainly a cycloaliphatic modified group, and may contain ethylenic groups, polyurethane groups, propylene oxide groups, etc.

Adjusting the molecular structure for modification is mainly to maintain both the material hardness and flexibility of the polyhedral oligomeric silsesquioxane. Since epoxy resin and acrylic resin on the market have better hardness and relatively poor flexibility and the polyhedral oligomeric silsesquioxane has the cage-like structure, the molecular structure design of the polyhedral oligomeric silsesquioxane has greater adjustability and the crosslinking density thereof can be enhanced, while the flexibility thereof can also be enhanced with side chain modification.

In some embodiments of the present disclosure, the functionality of the multifunctional epoxy resin can be, for example, a 3-4 functionality cycloaliphatic epoxy resin, or a 3-4 functionality carboxylated epoxy resin, but the present disclosure is not limited thereto.

In some embodiments of the present disclosure, the cationic light initiator is at least one material selected from a group consisting of azo compound, acrylate compound, fluorine-containing iodine phosphates, and fluorinated antimonate.

The reaction mechanism of the cationic light initiator is that the multifunctional epoxy resin is irradiated with ultraviolet light to excite molecules thereof, so that the molecules thereof are decomposed to generate protonic acid, so as to carry out polymerization on epoxy compounds, vinyl ethers, acetals, etc. Furthermore, epoxy-type photohardening polymers will generate cations for polymerization when being exposed to the ultraviolet light, and when the epoxy-type photohardening polymers stop being exposed to the ultraviolet light, the cations can survive for a few days, and the above-mentioned reaction continues during this period and can ensure complete hardening with heat treatment.

In some embodiments of the present disclosure, the organic solvent is at least one material selected from a group consisting of methyl ethyl ketone (MEK), propylene glycol methyl ether acetate (PMA), propylene glycol monomethyl ether (PM), and methyl isobutyl ketone (MIBK). The above-mentioned organic solvent is particularly suitable for the solubilization of polyhedral oligo-sesquioxane resins.

More specifically, the polarities of the above-mentioned organic solvent and the resin of the embodiment of the present disclosure are similar, and the above-mentioned organic solvent can provide better solubility to the resin material of the embodiment of the present disclosure. The selection of the organic solvent is mainly designed according to the process conditions and with consideration to the film-forming drying curve that is matched with a variety of solvents, so that the resin can be dissolved and the solvent can be easily removed during the process to cure the resin. If the temperature is too high, the substrate will be deformed, and if the temperature is too low, the residual solvent will easily affect the physical properties of the resin.

In some embodiments of the present disclosure, the processing aid is at least one material selected from a group consisting of organic modified silicon oxide, aluminum oxide nanomaterials, leveler, and defoamer. The above-mentioned processing aid can be used to make the coating layer that is subsequently formed have scratch resistance, abrasion resistance, chemical resistance, hydrophobicity, etc.

The organic modified silicon oxide or aluminum oxide nanomaterials can be used to improve the scratch resistance, the abrasion resistance, and the toughness of the coating layer that is subsequently formed. The leveler, such as polysiloxane modified with polyacrylate functional group, organosilicon acrylic finger, polyether polyester modified organosiloxane, and fluorine modified acrylate, etc., can be used to improve the leveling and surface slipperiness of the coating layer.

The defoamer, such as polyoxyethylene polyoxypropylene pentaerythritol ether, polyoxyethylene polyoxypropanolamine ether, polyoxypropylene glycerol ether, polyoxypropylene polyoxyethylene glycerol ether, polydimethylsiloxane, etc., can be used to reduce air bubbles in the coating solution so that the coating layer is more uniform.

Each component in the coating composition has a specific content range. Specifically speaking, based on a total weight of the coating composition being 100 wt %, a content of the polyhedral oligomeric silsesquioxane is within a range from 6 wt % to 40 wt %, preferably from 9 wt % to 30 wt %, a content of the multifunctional epoxy resin is within a range from 3 wt % to 35 wt %, preferably from 5 wt % to 25 wt %, a content of the cationic light initiator is within a range from 1 wt % to 10 wt %, preferably from 2 wt % to 6 wt %, a content of the organic solvent is within a range from 30 wt % to 70 wt %, preferably from 40 wt % to 55 wt %, a content of the processing aid is within a range from 5 wt % to 30 wt %, and preferably from 8 wt % to 18 wt %, but the present disclosure is not limited thereto.

According to the material selection and composition content range of the above-mentioned coating composition, the coating composition is preferably suitable for the subsequent coating process, so that the coating layer with scratch resistance and flex resistance is easily formed.

In some embodiments of the present disclosure, the plastic substrate 200 is selected according to the following conditions: the plastic substrate 200 being evaluated according to heat resistance, with a baking temperature that is within a range from 150° C. to 250° C., a baking time that is within a range from 2 hours to 4 hours, a longitudinal (MD) shrinkage rate of the plastic substrate 200 that must be no more than 0.5, a transverse (TD) shrinkage rate of the plastic substrate 200 that must be no more than 0.3, and a haze difference between the plastic substrate 200 before and after baking that must be no more than 20%.

According to the above-mentioned configuration, the plastic substrate 200 can maintain great dimensional stability and visible light transmittance after carrying out the following curing operation of the present disclosure.

In some embodiments of the present disclosure, the plastic substrate 200 is formed of a resin material, and the resin material is at least one material selected from a group consisting of polyethylene terephthalate (PET), polyvinyl chloride (PVC), polycarbonate (PC), polypropylene (PP), poly(methyl methacrylate) (PMMA). The selected materials of the above-mentioned plastic substrate 200 all have properties such as flexibility and high visible light transmittance.

As shown in FIG. 3, the step S120 includes performing the curing operation on the coating composition 100 to form a cured coating layer 100′.

More specifically, the step S120 includes performing the curing operation on the coating composition 100, so that the polyhedral oligomeric silsesquioxane resin (POSS) and the polyfunctional epoxy resin of the coating composition 100 carry out the curing operation, and then the coating composition 100 is formed on the plastic substrate 200 as the cured coating layer 100′.

In the curing operation, the organic solvent in the coating composition 100 is removed by being heated and evaporated, and the polyhedral oligomeric silsesquioxane (POSS) and the polyfunctional epoxy resin carry out a crosslinking reaction to increase the molecular weight thereof.

In some embodiments of the present disclosure, the curing operation has a baking temperature that is within a range from 75° C. to 200° C., and preferably from 75° C. to 150° C.

In some embodiments of the present disclosure, the curing operation has a baking time that is within a range from 30 s to 120 s, and preferably from 30 s to 90 s.

In some embodiments of the present disclosure, the curing operation has an UV curing energy that is within a range from 250 mJ/cm² to 1,250 mJ/cm², and preferably from 250 mJ/cm² to 1,000 mJ/cm².

In some embodiments of the present disclosure, the curing operation needs to be carried out at least under a temperature-controlled and humidity-controlled operating environment (temperature of 23 degrees/humidity of 50 degrees). The operating environment is preferably a clean room 1000 class, and the curing operation is preferably carried out with UV lamp irradiation in a nitrogen environment.

In some embodiments of the present disclosure, in order to improve a binding force between the cured coating layer 100′ and the plastic substrate 200, before coating the coating composition 100 on the plastic substrate 200, the method further includes performing a corona treatment and/or coating a surfactant on a coating surface of the plastic substrate 200. Accordingly, the surface tension of the coating surface is reduced and the adhesion between the cured coating layer 100′ and the plastic substrate 200 is improved. In addition, the surface wetting tension of the substrate after the corona treatment needs to reach 48 to 60 dyne/cm. The surfactant is a polyester, a polyurethane, or an acrylic resin surface treatment agent.

In some embodiments of the present disclosure, the cured coating layer 100′ and the plastic substrate 200 respectively have a preferred thickness range. More specifically, a thickness D1 of the plastic substrate 200 is within a range from 38 μm to 250 μm, and a thickness D2 of the cured coating layer 100′ is within a range from 3 μm to 50 μm, but the present disclosure is not limited thereto.

According to the above-mentioned method, the cured coating layer 100′ of the embodiment of the present disclosure has scratch resistance, flex resistance, and high transparency at the same time. More specifically, the cured coating layer 100′ has a pencil hardness that is not less than 4H, a bending radius that is no more than 3 mm, and a visible light transmittance that is not less than 90%.

Accordingly, the cured coating layer 100′ of the embodiment of the present disclosure has the potential to replace the transparent colorless polyimide films that are used in applications such as cover plates or functional protective films of panel materials or electronic products. Furthermore, compared to the transparent colorless polyimide film, the cost of the cured coating layer 100′ of the embodiment of the present disclosure can provide market competitiveness.

### Laminated Structure

The method for producing the coating layer according to the present disclosure is described above. Next, a laminated structure formed by the above-mentioned method will be described. It should be noted that since the laminated structure is formed by the method of the above-mentioned embodiment, but the present disclosure is not limited thereto. For instance, the laminated structure can also be formed by other suitable manufacturing methods that are different from the method of the above-mentioned embodiment.

As shown in FIG. 3, an embodiment of the present disclosure provides a laminated structure, the laminated structure includes a plastic substrate 200 and a cured coating layer 100′, and the cured coating layer 100′ is formed on the plastic substrate 200. In addition, the cured coating layer 100′ contains a polyhedral oligomeric silsesquioxane and a multifunctional epoxy resin, and the polyhedral oligomeric silsesquioxane has a cage-like structure.

Furthermore, the cured coating layer 100′ has a pencil hardness that is not less than 4H, a bending radius that is no more than 3 mm, and a visible light transmittance that is not less than 90%.

### Coating Composition

An embodiment of the present disclosure also provides a coating composition 100, and the coating composition 100 contains a polyhedral oligomeric silsesquioxane (POSS), a multifunctional epoxy resin, a cationic light initiator, and an organic solvent. In addition, the polyhedral oligomeric silsesquioxane has a cage-like structure.

Based on a total weight of the coating composition being 100 wt %, a content of the polyhedral oligomeric silsesquioxane is within a range from 6 wt % to 40 wt %, a content of the multifunctional epoxy resin is within a range from 3 wt % to 35 wt %, a content of the cationic light initiator is within a range from 1 wt % to 10 wt %, and a content of the organic solvent is within a range from 30 wt % to 70 wt %.

### Experimental Data Test

Hereinafter, the contents of the present disclosure will be described in detail with reference to embodiments 1-3 and comparative embodiment 1. However, the following embodiments are only provided for the purpose of facilitating a better understanding of the present disclosure, and the scope of the present disclosure is not limited to these embodiments.

Embodiment 1: 10.2 parts by weight of polyhedral oligomeric silsesquioxane resin (POSS), 23.8 parts by weight of multifunctional epoxy resin, and 50 parts by weight of organic solvent (e.g., a mixed solvent of MEK, PMA, and PM) are mixed and stirred for 20 minutes until all the resin is completely dissolved in the organic solvent. Next, 13 parts by weight of additives (e.g., organic modified silicon oxide, leveling agent, and defoamer) and 3 parts by weight of cationic light-curing initiator are added and stirred evenly so that a coating composition is formed. Then, the coating composition is coated on the plastic substrate (e.g., PET substrate), baked in an oven at 120° C. for 90 s, cured by UV lamp at 600 mJ/cm², and left to stand at room temperature for 1-3 days after coating, and then the physical properties thereof are measured.

Embodiment 2: 20.4 parts by weight of polyhedral oligomeric silsesquioxane resin (POSS), 13.6 parts by weight of multifunctional epoxy resin, and 50 parts by weight of organic solvent (e.g., a mixed solvent of MEK, PMA, and PM) are mixed and stirred for 20 minutes until all the resin is completely dissolved in the organic solvent; Next, 13 parts by weight of additives (e.g., organic modified silicon oxide, leveling agent, and defoamer) and 3 parts by weight of cationic light-curing initiator are added and stirred evenly so that a coating composition is formed. Then, the coating composition is coated on the plastic substrate (e.g., PET substrate), baked in an oven at 120° C. for 90 s, cured by UV lamp at 600 mJ/cm², and left to stand at room temperature for 1-3 days after coating, and then the physical properties thereof are measured.

Embodiment 3: 27.2 parts by weight of polyhedral oligomeric silsesquioxane resin (POSS), 6.8 parts by weight of multifunctional epoxy resin, and 50 parts by weight of organic solvent (e.g., a mixed solvent of MEK, PMA, and PM) are mixed and stirred for 20 minutes until all the resin is completely dissolved in the organic solvent; Next, 13 parts by weight of additives (e.g., organic modified silicon oxide, leveling agent, and defoamer) and 3 parts by weight of cationic light-curing initiator are added and stirred evenly so that a coating composition is formed. Then, the coating composition is coated on the plastic substrate (e.g., PET substrate), baked in an oven at 120° C. for 90 s, cured by UV lamp at 600 mJ/cm², and left to stand at room temperature for 1-3 days after coating, and then the physical properties thereof are measured.

Comparative embodiment 1: 34 parts by weight of polyhedral oligomeric silsesquioxane resin (POSS) and 50 parts by weight of organic solvent (e.g., a mixed solvent of MEK, PMA, and PM) are mixed and stirred for 20 minutes until all the resin is completely dissolved in the organic solvent; Next, 13 parts by weight of additives (e.g., organic modified silicon oxide, leveling agent, and defoamer) and 3 parts by weight of cationic light-curing initiator are added and stirred evenly so that a coating composition is formed. Then, the coating composition is coated on the plastic substrate (e.g., PET substrate), baked in an oven at 120° C. for 90 s, cured by UV lamp at 600 mJ/cm², and left to stand at room temperature for 1-3 days after coating, and then the physical properties thereof are measured.

It should be noted that the main difference between the comparative embodiment 1 and the above-mentioned embodiments 1-3 is that the comparative embodiment 1 does not use the multifunctional epoxy resin.

The process parameter condition of each composition is organized as the following Table 1. More specifically, the coated laminated structures formed in the embodiments 1-3 and the comparative embodiment 1 are carried out in physicochemical properties tests, such as pencil hardness, bending radius, and visible light transmittance. The related test ways are described below, and the related test results are organized in Table 1.

Pencil hardness test: through use of a pencil hardness tester B-3084T3, placing the HC PET film on the glass surface, sliding the hardness tester (0.765 kgf) over the surface of the film at least 10 cm, and observing the surface with the naked eye and laser microscope for any scratches. If the surface has pencil marks, the pencil marks will be wiped away with an eraser to confirm whether or not the surface has scratches. The pencil hardness test is carried out at least 5 times, taking 3 out of five times to pass under the ASTM D3363 standard.

Bending radius test: through use of a Yuasa normal temperature inflection resistance tester (DMLHP-CS), cutting the film into 2*10 cm and fixing it on the machine stage with tape. The testable bending radius is between 0.5 to 3 mm, the bending speed is 30 cycle/min, and the count is set to 200,000 times.

Visible light transmittance and haze test: through use of a NDK NDH7000 haze meter. Cutting the film into 8*8 cm and placing it in the machine tool carrier, and the total light transmittance Tt and haze are measured in compliance with the ASTM D1003 standard.

TABLE 1
[Experimental Condition and Test Results]

| | | Embodiment | Embodiment | Embodiment | Comparative |
|---|---|---|---|---|---|
| Items | | 1 | 2 | 3 | embodiment 1 |
| Coating | Polyhedral oligosesquioxane | 10.2 | 20.4 | 27.2 | 34 |
| composition | resin content (wt) | | | | |
| | Multifunctional epoxy resin | 23.8 | 13.6 | 6.8 | 0 |
| | content (wt) | | | | |
| | Cationic light-curing | 3 | 3 | 3 | 3 |
| | initiator content (wt.) | | | | |
| | Organic solvent content(wt) | 50 | 50 | 50 | 50 |
| | Additive content(wt) | 13 | 13 | 13 | 13 |
| Curing | Baking temperature(° C.) | 120 | 120 | 120 | 120 |
| conditions | Baking time(sec) | 90 | 90 | 90 | 90 |
| | UV curing energy(mJ/cm²) | 600 | 600 | 600 | 600 |
| Physical and | Pencil hardness | 5H | 5H | 4H | 3H |
| chemical | Bending radius(mm) | 3 | 2 | 2 | 2 |
| properties | Visible light penetration | 90-91% | 90-91% | 90-91% | 90-91% |
| | rate | | | | |

### Discussion of Test Results

In the embodiments 1-3, the add ratio of the POSS resin to the epoxy resin is assessed. Because of the cage-like structure of the POSS resin, the cured coating layer can have better flexibility and hardness after formation of the cured coating layer. Furthermore, the epoxy resin can increase the crosslinking density of the overall resin so that the hardness, mechanical strength and heat resistance of the cured coating layer can be increased.

However, if the addition ratio of the epoxy resin is too high, the cured coating layer will be brittle and bending resistance thereof is poor. Therefore, the addition ratio of the POSS resin to the epoxy resin should be adjusted to allow the cured coating layer to have great hardness and bending resistance.

In the embodiment 1, the content of the epoxy resin is more than 20%, although the hardness of the cured coating layer can reach 5H, the bending radius is significantly increased. In the embodiment 3, the content of the epoxy resin is less than 10%, the overall crosslinking density of the cured coating layer is slightly lower, and the hardness of the cured coating layer is 4H. Accordingly, the embodiment 2 is a combination of formulations that provides better physical properties and simultaneously has both hardness and flexural resistance. In the comparative embodiment 1, it can be observed that if the epoxy resin is not added, the hardness of the cured coating layer decreases significantly. In addition, there is no significant difference in optical properties (penetration and haze) as a result of adjustments to the formulation.

### Beneficial Effects of the Embodiments

In conclusion, in the method for producing the coating layer with scratch resistance and flex resistance, the laminated structure, and the coating composition provided by the present disclosure, by virtue of “conditional material selection of the coating composition” and “process conditions for the curing operation,” the cured coating layer has high scratch resistance, flex resistance, and transparency, so that the cured coating layer of the present disclosure has the potential to replace the transparent colorless polyimide films that are used in applications such as cover plates or functional protective films of panel materials or electronic products. Furthermore, compared to the transparent colorless polyimide film, the cost of the cured coating layer of the embodiment of the present disclosure can provide higher market competitiveness.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a coating layer with scratch resistance and flex resistance, comprising:
coating a coating composition on a plastic substrate, wherein the coating composition contains a polyhedral oligomeric silsesquioxane, a multifunctional epoxy resin, a cationic light initiator, and an organic solvent, and the polyhedral oligomeric silsesquioxane has a cage-like structure; and
performing a curing operation on the coating composition to form a cured coating layer;
wherein the curing operation has a baking temperature that is within a range from 75° C. to 200° C., a baking time that is within a range from 30 s to 120 s, and a UV curing energy that is within a range from 250 mJ/cm² to 1,250 mJ/cm², and wherein the cured coating layer has a pencil hardness that is not less than 4H, a bending radius that is no more than 3 mm, and a visible light transmittance that is not less than 90%.

2. The method according to claim 1, wherein the polyhedral oligomeric silsesquioxane is a modified alicyclic group.

3. The method according to claim 1, wherein the plastic substrate is selected according to following conditions: the plastic substrate being evaluated according to heat resistance, with a baking temperature that is within a range from 150° C. to 250° C., a baking time that is within a range from 2 hours to 4 hours, a longitudinal shrinkage rate of the plastic substrate that is no more than 0.5, a transverse shrinkage rate of the plastic substrate that is no more than 0.3, and a haze difference between the plastic substrate before and after baking that is no more than 20%.

4. The method according to claim 1, wherein the plastic substrate is formed by a resin material, and the resin material is at least one material selected from a group consisting of polyethylene terephthalate, polyvinyl chloride, polycarbonate, polypropylene, and poly(methyl methacrylate).

5. The method according to claim 1, wherein the organic solvent is at least one material selected from a group consisting of methyl ethyl ketone, propylene glycol methyl ether acetate, propylene glycol monomethyl ether, ethyl ethanoate, and methyl isobutyl ketone.

6. The method according to claim 1, wherein based on a total weight of the coating composition being 100 wt %, a content of the polyhedral oligomeric silsesquioxane is within a range from 6 wt % to 40 wt %, a content of the multifunctional epoxy resin is within a range from 3 wt % to 35 wt %, a content of the cationic light initiator is within a range from 1 wt % to 10 wt %, and a content of the organic solvent is within a range from 30 wt % to 70 wt %.

7. The method according to claim 5, wherein the coating composition further contains a processing aid, and a content of the processing aid is within a range from 5 wt % to 30 wt %.

8. The method according to claim 1, wherein, before coating the coating composition on the plastic substrate, the method further includes performing a corona treatment and/or coating a surfactant on a coating surface of the plastic substrate.

9. The method according to claim 1, wherein a thickness of the plastic substrate is within a range from 38 μm to 250 μm, and a thickness of the cured coating layer is within a range from 3 μm to 50 μm.

10. A laminated structure, comprising:
a plastic substrate; and
a cured coating layer formed on the plastic substrate and containing a polyhedral oligomeric silsesquioxane and a multifunctional epoxy resin, wherein the polyhedral oligomeric silsesquioxane has a cage-like structure;
wherein the cured coating layer has a pencil hardness that is not less than 4H, a bending radius that is no more than 3 mm, and a visible light transmittance that is not less than 90%.

11. The laminated structure according to claim 10, wherein the plastic substrate is selected according to following conditions: the plastic substrate being evaluated according to heat resistance, with a baking temperature that is within a range from 150° C. to 250° C., and a baking time that is within a range from 2 hours to 4 hours, a longitudinal shrinkage rate of the plastic substrate that is no more than 0.5, a transverse shrinkage rate of the plastic substrate that is no more than 0.3, and a haze difference between the plastic substrate before and after baking that is no more than 20%.

12. A coating composition, characterized in that the coating composition contains a polyhedral oligomeric silsesquioxane, a multifunctional epoxy resin, a cationic light initiator, and an organic solvent, and the polyhedral oligomeric silsesquioxane has a cage-like structure, wherein based on a total weight of the coating composition is 100 wt %, a content of the polyhedral oligomeric silsesquioxane is within a range from 6 wt % to 40 wt %, a content of the multifunctional epoxy resin is within a range from 3 wt % to 35 wt %, a content of the cationic light initiator is within a range from 1 wt % to 10 wt %, and a content of the organic solvent is within a range from 30 wt % to 70 wt %.
